(19) United States
(12) Patent Application Publication
(10) Pub. No.: US 2014/0027648 A1
(43) Pub. Date: Jan. 30, 2014

(54) Neutron Detector

(71) Applicants: Sture Petersson, Uppsala (SE); Göran Thungström, Sundsvall (SE); Stanislav Pospisil, Praha (CZ); Tomas Slavicek, Kolin (CZ); David Krapohl, Sundsvall (SE)

(72) Inventors: Sture Petersson, Uppsala (SE); Göran Thungström, Sundsvall (SE); Stanislav Pospisil, Praha (CZ); Tomas Slavicek, Kolin (CZ); David Krapohl, Sundsvall (SE)

(21) Appl. No.: 13/462,060

(22) Filed: May 2, 2012

Related U.S. Application Data
(60) Provisional application No. 61/537,777, filed on Sep. 22, 2011.

(51) Int. Cl. G01T 3/08

(52) U.S. Cl. CPC G01T 3/08
USPC 250/370.05

(57) ABSTRACT

The invention relates to a neutron detector (1) comprising a semiconductor detector substrate (10) and a conductive neutron converting layer (20), such as of TiB₂. The neutron detector (1) thereby comprises a conductive contact made of a neutron conversion material (20).

### RELATED APPLICATION

The present application claims priority under 35 U.S.C. 119 of U.S. Application No. 61/537,777 filed Sep. 22, 2011.

### TECHNICAL FIELD

The present embodiments generally relate to a neutron detector, and in a particular to such a neutron detector having a conductive neutron converting layer.

### BACKGROUND

Neutron detection has its own place in nuclear research and homeland security and since “The ³He Supply Problem” [1] occurred there has been a demand for new approaches to neutron radiation detection.

Neutron radiation is a non-ionizing radiation of neutral particles. Hence, they are generally harder than charged particles to detect directly. Further, their paths of motion are not affected by electric fields and merely weakly affected by magnetic fields.

There are generally three main detection techniques used today. Firstly, nuclear reactions where low energy neutrons are detected indirectly through their absorption in a material having high cross sections for absorption of neutrons and specifically containing isotopes as ³He, ⁶Li, ¹⁰B and ²³⁵U. Each of these reacts by emission of high energy ionized particles, the ionization track of which are detected. Secondly, activation processes can be used where neutrons may be detected by reacting with absorbers in a radiative capture or spallation reaction, producing reaction products which then decay to release beta particles or gamma radiation. Thirdly, elastic scattering reactions (proton-recoil) can be used to indirectly detect high energy neutrons. Neutrons collide with the nucleous of atoms in the detector, transferring energy to the nucleous and creating an ion, which is detected.

Documents [2, 3] disclose a dosimetry-based neutron detector for detecting high energy neutron radiation with a neutron converter and a detection element.

There is, though, still a need for a neutron detector that can be easily manufactured and provide reliable detection of neutron radiation.

### SUMMARY

The present embodiments generally relate to a neutron detector comprising a semiconductor detector substrate having a first or front side and a second or back side. A conductive neutron converting layer is present on the first or front side and a conductive metal layer is present on the second or back side. The conductive neutron converting layer is preferably made of TiB₂.

Hence, an aspect of the embodiments relates to a neutron detector comprising a semiconductor detector substrate having a front side and a back side. A first electrical contact is present on the front side and comprises a conductive neutron converting layer. A second electrical contact is present on the back side and comprises a conductive layer.

In an embodiment, the conductive neutron converting layer is made of a conductive material comprising isotopes that are sensitive to neutrons and convert incident neutrons to detectable particle species. The conductive neutron converting layer is, in an embodiment, made of a conductive boride material, such as titanium diboride. In a particular embodiment, the conductive neutron converting layer is made of enriched titanium diboride with regard to a ¹⁰B isotope and boron in the enriched titanium diboride is present in at least 20% as the ¹⁰B isotope. A conductive neutron converting layer made of a conductive boride material as exemplified above will convert incident neutrons into alpha particles and ⁷Li particles. The alpha particles and the ⁷Li particles create an electron current in the semiconductor detector substrate.

In an embodiment, the conductive neutron converting layer has a thickness from about 1 nm to about 10 μm, such as from about 100 nm to about 1 μm.

In a particular embodiment, the semiconductor detector substrate comprises a three-dimensional structure in the front side. For instance, the front side may be serrated forming multiple sawteeth. In such a case, the first electrical contact is preferably deposited on the sawteeth.

In an embodiment, the first electrical contact comprises a gluing layer arranged between the conductive neutron converting layer and the semiconductor detector substrate. The gluing layer may be one of a titanium layer and a chrome layer or another conductive adhesive layer. In an embodiment, the gluing layer has a thickness from about 10 nm to about 100 nm.

In an embodiment, the first electrical contact comprises a conductive metal layer arranged on a first side of the conductive neutron converting layer that is opposite to a second side of the conductive neutron converting layer facing the semiconductor detector substrate. The conductive metal layer may be made of a metal selected from a group consisting of aluminum, silver, gold and titanium. In a particular embodiment, the conductive metal layer is made of a same conductive metal material as the conductive layer on the back side of the semiconductor detector substrate. In an embodiment, the conductive metal layer has a thickness that is substantially the same as a thickness of the conductive layer.

In an embodiment, the conductive layer is a conductive metal layer. The conductive metal layer may be made of a metal selected from a group consisting of aluminum, silver, gold and titanium. In an embodiment, the conductive layer has a thickness from about 1 nm to about 1 mm, such as from about 100 nm to about 1 μm.

In an embodiment, the neutron detector is a pixel-based or pixilated neutron detector with the conductive layer arranged in the form of multiple separate metal portions forming a grid on the back side. The semiconductor detector substrate is, in an embodiment, doped to comprise a PN-junction. In a preferred embodiment, the distance between the PN-junction in the semiconductor detector substrate and the neutron converting layer is longer than the distance between the PN-junction in the semiconductor detector substrate and the conductive layer.

In an embodiment, the semiconductor detector substrate is a silicon-based detector substrate. In a particular embodiment, the silicon-based detector substrate is a silicon PN diode. In another particular embodiment, the semiconductor detector substrate is doped to comprise a PN-junction. In an implementation of these embodiments, the semiconductor detector substrate has a p-type semiconductive part facing the conductive neutron converting layer and a remaining n-type semiconductive part. In a particular embodiment, the distance between the PN-junction in the semiconductor detector substrate and the neutron converting layer is shorter than the distance between the PN-junction in the semiconductor detector substrate and the conductive layer.

In an embodiment, the neutron detector is configured to detect at least one of thermal neutrons, epithermal neutrons and resonance neutrons.

In an embodiment, the first electrical contact forms an ohmic contact with the semiconductor detector substrate.

In an embodiment, the neutron detector further comprises a second semiconductor detector layer having a front side and a back side. The back side of the second semiconductor detector layer is preferably connected to a first side of the first electrical contact opposite to a second side of the first electrical contact connected to the semiconductor detector layer. A third electrical contact is preferably present on the back side of the second semiconductor and comprises a conductive layer.

### BRIEF DESCRIPTION OF THE DRAWINGS

The invention, together with further objects and advantages thereof, may best be understood by making reference to the following description taken together with the accompanying drawings, in which:

FIG. 1 is a schematic illustration of a neutron detector according to an embodiment;

FIG. 2 is a schematic illustration of a neutron detector according to another embodiment;

FIG. 3 is a schematic illustration of a neutron detector according to a further embodiment;

FIG. 4 is a schematic illustration of a neutron detector according to yet another embodiment;

FIG. 5 is a schematic illustration of a neutron detector with a stacked detector solution according to an embodiment;

FIG. 6 is a schematic illustration of a neutron detector with a three-dimensional structure according to an embodiment;

FIG. 7 illustrates schematics of metallic layers composition according to an implementation embodiment of a neutron detector;

FIG. 8 illustrates energy calibrated P/H spectra measured with a detector without any converting layer using mixed alpha source;

FIG. 9 illustrates energy calibrated P/H spectra measured with a detector with a converter layer using mixed alpha source;

FIG. 10 illustrates energy calibrated P/H spectra measured with a detector without a converter layer using CMI's neutron source

FIG. 11 illustrates energy calibrated P/H spectra measured with a detector with a converter layer using CMI's neutron source

FIG. 12 schematically illustrates the irradiation chamber used in the present experiments;

FIG. 13 illustrates a test set up with a neutron detector in a shielded box connected to a charge sensitive amplifier;

FIG. 14 is a schematic overview of the active part of the neutron detector that was simulated in Geant4;

FIG. 15 illustrates α-particle count in Si for a single TiB₂ layer;

FIG. 16 illustrates α-particle count in Si for a detector featuring all layers in FIG. 14;

FIG. 17 illustrates a comparison of two alpha spectra simulated with 2000 Å and 10000 Å TiB₂ layer thickness;

FIG. 18 is a combined histogram of neutrons and gamma photon simulation for a Si detector coated with only Al;

FIG. 19 is a combined histogram of gamma and neutron simulations for the Si—Ti—TiB₂—Al detector with a 2000 Å TiB₂ layer; and

FIG. 20 illustrates measurements with a ²⁴¹AmBe neutron source over 15 hours and 16 minutes.

### DETAILED DESCRIPTION

Throughout the drawings, the same reference numbers are used for similar or corresponding elements.

The present embodiments generally relate to a neutron detector and in particular such a neutron detector that uses a conductive neutron converting layer to generate particle species that can be detected from incident neutron radiation.

The neutron detector according to the embodiments is based on a semiconductor detector onto which the conductive neutron converting layer is deposited. Hence, incident neutron radiation will be converted in the conductive neutron converting layer into particle species that are then detected by the semiconductor detector.

In traditional neutron detectors electrical contacts of standard semiconductive neutron detectors are made of different metals, such as Ag, Al or Ti. However, according to particular embodiments, at least one of the contacts of the neutron detector is not only used as conductive electrical contact but also as neutron converter. Such neutron converters are materials with high neutron capture cross section.

The conductive neutron converting layer of the embodiments is made of a material that is conductive and able to form electrical contact, such as ohmic contact, with the semiconductive detector material. The material should also be chemically and physically stable to not deteriorate during use of the neutron detector.

According to the embodiments, the conductive neutron converting layer of the neutron detector comprises a conductive material with isotopes that are sensitive to neutrons and can convert incident neutrons to detectable particle species. In a particular embodiment, the conductive neutron converting layer is made of a conductive boride material. An example of a preferred such conductive boride material is titanium diboride (TiB₂). TiB₂ has all the qualities mentioned above and is a ceramic compound usually used as surface hardener. The material has electrical conductivity of about 10⁵ S/cm (electrical resistivity of about 10⁻⁵ Ωm). The TiB₂ converting layer of the neutron detector can be made of non-enriched TiB₂. In a non-enriched or natural form B is typically present in about 19.8% as the isotope ¹⁰B. However, in a particular embodiment, the titanium diboride of the converting layer is preferably an enriched TiB₂ with regard to the ¹⁰B isotope. Thus, the TiB₂ material preferably has a higher percentage of ¹⁰B than naturally occurring B. In a particular embodiment, the converting layer is made of Ti¹⁰B₂, i.e. the boron is present in at least 20%, at least 30%, at least 40%, at least 50%, at least 60%, at least 70%, at least 80% or at least 90%, such as at least 95% or close to 100% as the ¹⁰B isotope. Generally, the higher the quantity of the boron that is in the form of ¹⁰B, the higher the sensitivity of the neutron detector.

The neutron detector comprises a semiconductor detector in which particle species generated in the conductive neutron converting layer creates an electric charge (electron/hole pairs) that can be detected according to techniques well known in the art. The semiconductor detector could be a silicon-based detector and in particular a silicon PN diode. The embodiments are, however, not limited to silicon-based detectors but can instead use other semiconductive materials including silicon carbide (SiC), gallium arsenide (GaAs), cadmium telluride (CdTe), boron nitride (BN), silicon carbide (SiC), germanium (Ge), diamond, etc. The semiconductive material is preferably doped to comprise a PN-junction with a p-type semiconductive part facing the conductive neutron converting layer and with the remaining part of the semiconductor detector as n-type. In the case of a pixel-based detector, the p-type semiconductive part faces the conductive neutron converting layer and with the n-type facing the pixels.

The neutron detector of the embodiments can be used to detect incident neutron radiation. The boron-based neutron detector is in particular suitable for detecting thermal, epithermal and/or resonance neutrons, and in particular thermal neutrons. Generally, the low energy region neutrons have an energy of less than about 1 eV, the resonance region neutrons have an energy from about 1 eV to about 0.01 MeV followed by higher neutron energy for the continuum region neutrons (from about 0.01 MeV to 25 MeV). Thermal neutrons have an energy of about 0.025 eV and belong to the low energy region neutrons as do slow neutrons having an energy less than or equal to about 0.5-1 eV (sometimes less than or equal to about 0.4 eV). Epithermal neutrons have an energy from about 1 eV to about 10 keV and therefore belong to the resonance region.

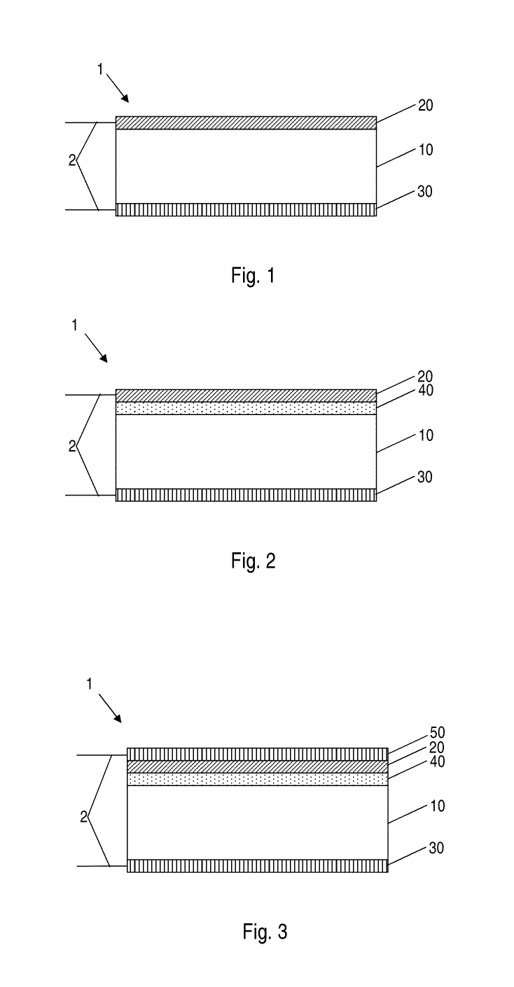

FIG. 1 is a schematic illustration of a neutron detector 1 according to an embodiment. The neutron detector 1 comprises the semiconductor detector substrate 10 onto which a conductive neutron converting layer 20, such as TiB₂, is deposited. Thus, the conductive neutron converting layer 20 is present one of the sides of the semiconductor detector 10, typically denoted the front side of the semiconductor detector 10. In this embodiment, the conductive neutron converting layer 20 forms one of the electrical contacts of the semiconductor detector 10. The other electrical contact is present on the opposite side, i.e. back side, of the semiconductor detector 10. This electrical contact is made of a conductive layer 30, preferably a conductive metal layer 30 of, for instance, aluminum (Al), silver (Ag), gold (Au), titanium (Ti), etc. It is also possible that the conductive layer 30 could be made of the same conductive material as the conductive neutron converting layer 20, such as TiB₂. The electrical contacts are then connected to a read-out unit (not illustrated) through contacts 2.

The conductive neutron converting layer 20, preferably TiB₂, can be deposited directly onto the semiconductor detector 10 as illustrated in FIG. 1 according to techniques further discussed herein.

The thickness of the conductive neutron converting layer 20 can be optimized based on the particular neutron radiation to be detected. Generally, if the layer 20 is too thick the formed particle species will not penetrate into the semiconductor detector 10 and the sensitivity of the neutron detector 1 will fall. Correspondingly, if the layer 20 is too thin the efficiency of the neutron detector 1 will be low as the chances of neutrons generating detectable particle species decrease as the neutron radiation incidences onto the conductive neutron converting layer 20. Generally, the thickness could be from about 1 nm to about 10 μm, preferably from about 10 nm to about 1 μm, more preferably from about 100 nm to about 1 μm. Expressed differently, the conductive neutron converting layer 20, preferably TiB₂ is preferably not thicker than about 0.5-1.0 mg TiB₂ /cm².

The conductive layer 30 can have a thickness according to prior art neutron detectors and the (ohmic) contact layers used therein. Thus, the conductive layer could have a thickness from about 1 nm to about 1 mm, such as about 10 nm to about 100 μm, or from about 10 nm to about 10 μm, such as from about 100 nm to about 1 μm.

In an embodiment, the adhesion between the conductive neutron converting layer 20 and the semiconductor detector 10 can be increased by providing a thin gluing or adhesive layer 40 between the conductive neutron converting layer 20 and the semiconductor detector 10 as illustrated in FIG. 2. The gluing layer 40 is preferably a conductive layer and is used to enhance the adhesion between the conductive neutron converting layer 20 and the semiconductor detector 10. Such gluing layers 40 can be in the form of a thin titanium layer or a thin chrome layer. Also other conductive materials used in the art to attach metal or ceramic layers onto a semiconductor material can be used. Generally, the gluing layer 40 is as thin as possible to thereby not interfere with passage of the particles species formed in the conductive neutron converting layer 20. Generally, a gluing layer 40 of about 10-100 nm could be used, such as about 50 nm.

If the conductive layer 30 is made of a same material as the conductive neutron converting layer 20, such as TiB₂, a second gluing layer (not illustrated) can be provided between the conductive layer 30 and the semiconductor detector 10 similar to the (first) gluing layer 40 between the conductive neutron converting layer 20 and the semiconductor detector 10.

In a further embodiment, a conductive metal layer 50 can be deposited onto the side of the conductive neutron converting layer 20 that is opposite to the semiconductor detector 10 or the gluing layer 40, if present. This is schematically illustrated in FIG. 3. In such a case, this conductive metal layer 50 can constitute part of one of the electrical contacts with the other previously described conductive metal layer 30 as the other electrical contact. The conductive metal layer 50 can be made of conductive metal materials disclosed in the foregoing in connection with the other conductive layer 30. The thickness could also be in the range as previously disclosed herein for the other conductive layer 30. In a particular embodiment, the two conductive layers 30, 50 are made of the same conductive metal material, such as Al, and have substantially the same thickness.

In an alternative implementation of the embodiment of FIG. 3, the gluing layer 40 is omitted.

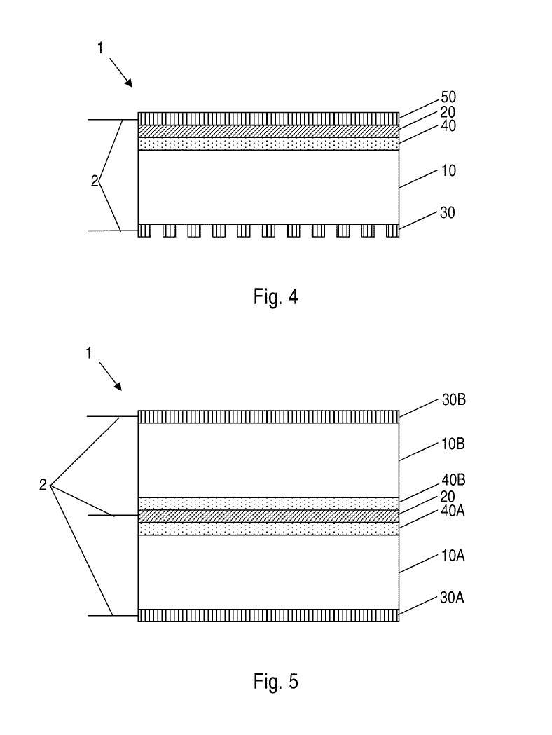

The neutron detector 1 of the embodiments is advantageously a pixel-based neutron detector as illustrated in FIG. 4. Thus, in this case the electrical contact of the conductive layer 30 on the back side of the semiconductor detector 10 is in the form of multiple separate metal portions forming a grid or matrix on the back side of the semiconductor detector 10. Each such metal portion then corresponds to one pixel of the neutron detector 1. For instance, the grid could be of 256×256 pixels, with a size of 55×55 μm as a non-limiting examples. Other grid sizes and pixel sizes are possible and within the scope of the embodiments. For instance, the pixel size could be smaller than 55×55 μm, such as in the range of 10-40 μm, or preferably 20-30 μm.

In the case of a pixel-based solution PN-junctions are preferably present on top of the conductive layer portions and are thereby present in the portion of the semiconductive detector 10 facing the conductive layer 30. The conductive layer portions and the PN-junctions enabling pixel-based detection can optionally be separated from each other by guard rings (not illustrated). Thus, for a pixel-based detector solution the PN-junctions are present close to the conductive layer 30 in FIG. 4, whereas for non-pixel-based detector solutions as illustrated in FIGS. 1-3, the PN-junction is preferably present close to the conductive neutron converting layer 20 (FIG. 1) or the gluing layer 40 (FIGS. 2 and 3).

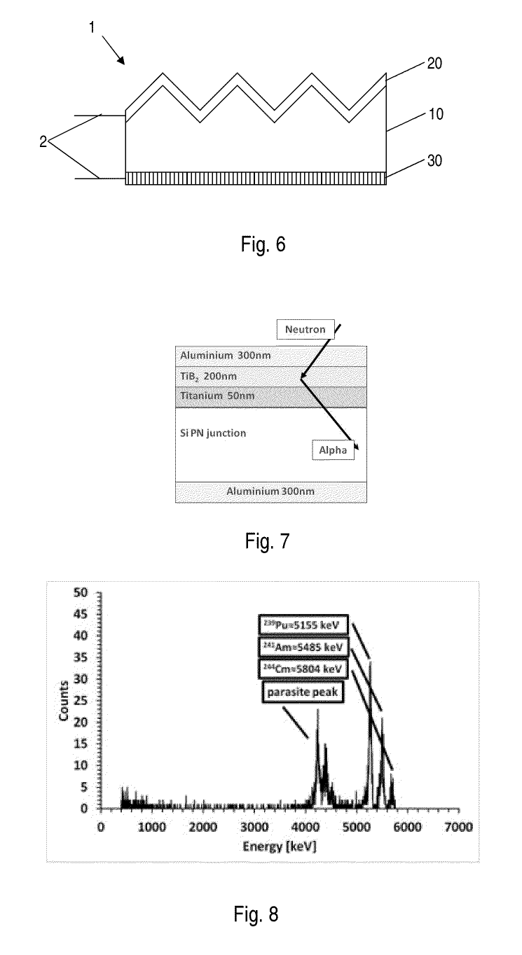

This pixel-based solution of the conductive layer 30 can be used in connection with any of the embodiments previously described herein and disclosed in FIGS. 1-3 (and furthermore for the embodiments disclosed in FIG. 5 or FIG. 6).

The conductive neutron converting layer of the embodiments when using TiB₂ as converting material converts incident neutrons (n) into alpha particles (α) and ⁷Li particles:

¹⁰B+n [symbol] α(1.47 MeV)+⁷Li(0.84 MeV)+γ(0.48 MeV) 94% probability

¹⁰B+n [symbol] α(1.78 MeV)+⁷Li(0.1 MeV) 6% probability

The neutron detector of the embodiments can then detect any of the alpha particles and the ⁷Li particles, which both give raise to an electron current in the semiconductor detector. The emission of an alpha particle and a ⁷Li particle produced by slow neutrons in the conductive neutron converting layer is typically isotropic. This means that the two particles exit the conversion point in the conductive neutron converting layer at substantially 180° relative to each other.

The efficiency of the neutron detector 1 can be increased by about a factor of two when using a stacked detector solution as illustrated in FIG. 5. Thus, in this case the neutron detector 1 comprises the conductive neutron converting layer 20 that is present intermediate two semiconductor detectors 10A, 10B present on either side of the conductive neutron converting layer 20. The neutron detector 1 may optionally comprise a respective gluing layer 40A, 40B between the conductive neutron converting layer 20 and the two semiconductor detectors 10A, 10B as illustrated in FIG. 5. The conductive neutron converting layer 20 then constitutes an electrical contact for each of the semiconductor detectors 10A, 10B. A respective conductive layer 30A, 30B is present on the back sides of the semiconductor detectors 10A, 10B and is used as the other electrical contact. In this embodiment, the alpha particle form by converting a neutron in the conductive neutron converting layer 20 will continue into one of the semiconductor detectors 10A, 10B whereas the formed ⁷Li particle will continue into the other of the semiconductor detectors 10A, 10B.

The efficiency and sensitivity of the neutron detector 1 can also be increased by using a three-dimension (3D) detector structure as compared to a planar (two-dimensional) structure as illustrated in FIGS. 1-5. For instance, the surface area of the conductive neutron converting layer can be increased by forming holes, pyramids, pillars, etc. in the front side of the semiconductor detector in or over which the conductive neutron converting layer is filled. FIG. 6 schematically illustrates an embodiment of a 3D structure that increases the total surface area of the detector 1. Thus, the front side is serrated with the conductive neutron converting layer 20 deposited on the sawteeth in the front side. In this embodiment, the gluing layer and the conductive layer has been omitted. In alternative embodiments, the gluing layer and/or conductive layer can be present.

The neutron detector of the embodiments has several advantageous characteristics. It has fairly high efficiency by using a denser converter that is electrically conductive. This efficiency can be even further enhanced through isotope doping and/or using a 3D structured converting layer. The neutron detector is reliable and stable and is not as sensitive to mechanical scratching as other neutron detectors in the art. The neutron detector can achieve a high position resolution to thereby be used as a position-sensitive detector for neutron imaging. Thus, the TiB₂ technology, enabling manufacture of thin conductive neutron converting layers, allows for the production of neutron detectors with high position resolution that can, for instance, be used for neutron imaging.

A further advantage is that the neutron detector can be operated at low or even unbiased operation conditions. The neutron detector is very insensitive to gamma radiation, which are commonly accompanying neutron fields. This implies less noise but also higher stability for the neutron detector.

The neutron detector of the embodiments can find uses within various technical fields. For instance, the neutron detector can be used in material analysis based on neutron radiation with applications within, for instance, biology, medicine, energy and material fields. Such material analysis needs neutron detectors with high resolution.

Furthermore, the neutron detector can be used in connection with neutron imaging, for instance, as applied to security and surveillance in order to detect explosives among others. Also, the neutron detector could be used as a position sensitive detector or pixel-based detector.

The neutron detector of the embodiments can be manufactured by depositing the conductive neutron converting layer onto a semiconductor detector wafer or substrate or onto a gluing layer present on the front side of the semiconductor detector wafer or substrate. This deposition can be performed by, for instance, electron beam-physical vapour deposition (EB-PVD). The method also involves depositing the conductive layer on the opposite, back side of the semiconductor detector wafer or substrate. In an optional embodiment, pixels are formed in the conductive layer according to techniques well known in the art. In addition, PN-junctions are formed in this pixel-based detector solution to be present in the semiconductor detector waver connected to the respective pixels.

### Experiments

Neutron radiation as a non-ionizing radiation is particularly difficult to detect, therefore a conversion material is needed. An effective way is to convert neutrons into secondary charges particles that are detectable. The conversion material converts neutrons into secondary charged particles to be detected in a silicon detector. The use of titanium diboride (TiB₂) as the conversion material deposited by electron beam-physical vapour deposition (EB-PVD) as a part of the front side contact of a planar silicon detector is presented herein. The detector behaviour was examined using alpha particles and neutrons.

Detector Design and Fabrication

Silicon Diode

The detector itself is a silicon diode with PN junction made from a 300 μm thick wafer. The epitaxial layer is between 50 and 60 μm, phosphorous doping 1e14 cm⁻³ (resistivity about 40 Ωcm). The detector process flow is comparable to the flow of a standard diode process and as described in literature [2]. The process deviated from standard only in one step: instead of a simple single aluminium layer front side contact, three different metal layers were deposited on the front side of the detector.

Front Side Contact

Ohmic contacts of standard silicon diode can be made from different metals (Ag, Al, Ti, etc.) [3]. The idea was to have the front side contact not only as conductive ohmic contact but also as neutron converter. Neutron converters are materials with high neutron capture cross section. This application requires the converter to be conductive and to be able to form an ohmic contact with silicon, to be chemically and physically stable and which can be deposited by standard clean room processes. Titanium diboride (TiB₂) ([4], [5], [6]) possesses all these qualities and was chosen as the material for the front side contact. Titanium diboride is a ceramic compound usually used as a surface hardener, which has an electrical conductivity of about 10⁵ S/cm and thanks to ¹⁰B it has ability to act as neutron converter. Boron naturally occurs in the form of two isotopes, ¹⁰B and ¹¹B, where natural abundance of ¹⁰B is 19.8%.

Electron Beam—Physical Vapour Deposition (EB-PVD), which is a standard technique in semiconductor processing to deposit metallic layers on top of semiconductor, was used to deposit TiB₂. During first trial run, to acknowledge the reliability of this technique, 300 Angstrom (Å) of titanium and 3000 Å of TiB₂ were deposited on a silicon wafer. However, because of the adhesion of TiB₂ and its different coefficient of thermal expansion, the TiB₂ started to flake off from the detector surface. In a second trial run, where 500 Å of titanium, 2000 Å of TiB₂ and 3000 Å of aluminium were deposited, no more problems with flaking arose and the decision was made to adopt this metal layers composition (FIG. 7) was decided to form the front side contact. The back side contact was in the form of a deposition of a 3000 Å thick layer of aluminium. To etch patterns into TiB₂ of the front side contact, a solution which consisted of 20 parts of H₂O: 1 part H₂O₂:1 part HF was tested and used. This solution performed the etching at an acceptable speed and low under-etch. The etched pattern was in the form of two concentric squares; a central main electrode and a surrounding strip having a function of a field plate.

Detection Tests

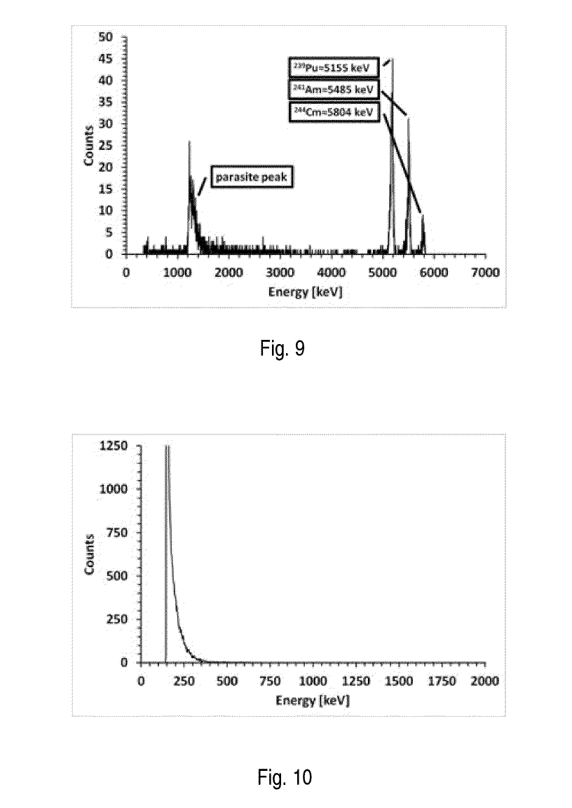

The first tests to be conducted with the neutron detector were current—voltage and capacitance—voltage measurements in order to confirm that the detector manufacturing process for the detectors has been performed correctly and that the detector did indeed behave as a diode. These electrical tests were complemented with alpha spectroscopy measurements. Alpha spectroscopy provides information about the detection ability of the detector, its energy resolution and it also provides energy calibration of the pulse height spectra (P/H) (FIG. 8 and FIG. 9).

Alpha spectroscopy was performed in a vacuum chamber using a mixed alpha particle source with characteristic lines at 5155 keV, 5485 keV and 5804 keV from ²³⁹Pu, ²⁴¹Am and ²⁴⁴Cm respectively. The alpha spectroscopy measurements validated the ability of the detector to perform energy dependent particle detection. Spectroscopic measurements were done with two different detectors; a detector with the conversion layer and a detector without the conversion layer. There was no significant difference in spectra of alpha particle source for the two detectors, see FIGS. 8 and 9.

FIGS. 8 and 9 (FIG. 8, detector without conversion layer and FIG. 9, detector with conversion layer) demonstrate that the detector technology with conductive neutron converting layer made of TiB₂ work really well and produces good spectral resolution as seen from the three distinct peaks in FIG. 9.

On the left side of the alpha particle spectra (FIG. 8 and FIG. 9), next to the alpha source peaks, parasite peaks can be seen. The explanation for this effect lies in the structure of the front-side electrode of the detector. As this effect was noted for both the detectors, i.e. with and without the converter, it must be independent of its composition. The problem was caused by a mask used for front-side electrode lithography. The front-side electrode is designed as two concentric squares; in which the central main electrode and the surrounding strip have the function of a field plate. The parasite signal comes from this region.

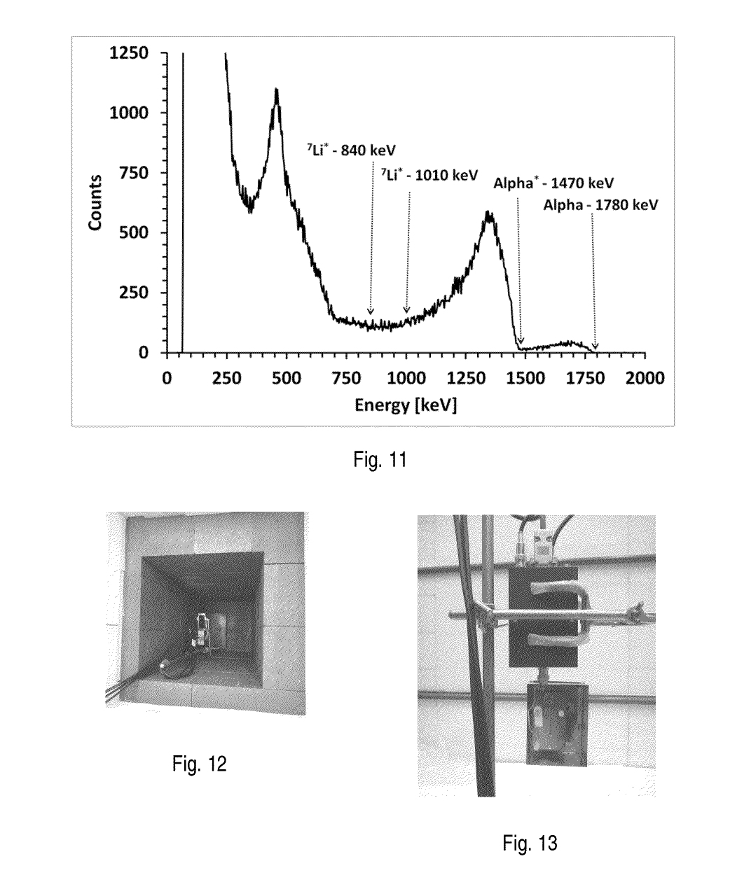

For first thermal neutron detection tests a Mid Sweden University ²⁴¹AmBe neutron source placed in a moderating environment was used. The results showed a peak corresponding to the alpha product of the reaction of a neutron with ¹⁰B at 1470 keV and confirmed the sensitivity of the detector to neutrons. The results were also confirmed with a reference thermal neutron source at the Czech Metrology Institute (CMI) [8] (made of ²⁴¹AmBe neutron sources placed in graphite moderator with neglectable contribution of gamma rays and energetic neutrons). The neutron source provided a homogeneous thermal neutron field with a flux of 1e4 n/cm²s. The measurement in the neutron field was conducted using detectors with (FIG. 11) and without (FIG. 10) the converting layer. In FIG. 10, only the noise of the measurement system and the signal from the background are shown, there are no other specific peaks. There was confirmation that the silicon sensor is insensitive to neutrons without any conversion layer. In FIG. 11, several peaks are well pronounced. FIG. 11 hence clearly demonstrates that a detector comprising a conductive neutron converting layer made of TiB₂ is capable of neutron detection.

A comparison of the energies of the peaks with energies of n+¹⁰B reaction products affirmed that the peaks have their origin in the interaction of the neutrons with the converter. There are two alpha particle peaks with peak edges at 1470 keV and 1780 keV and one peak with an edge at approximately 840 keV which was assumed to be from the ⁷Li nuclei. The efficiency of the neutron detection was calculated to approximately 0.03%.

FIG. 12 illustrates a view into the irradiation chamber used for the experiments presented in FIGS. 8 to 11 and FIG. 13 illustrates the neutron detector in a shielded box, connected to a charge sensitive amplifier.

### CONCLUSIONS

The idea of making a thermal neutron sensitive detector with a TiB₂ converter as a part of the detector contact was examined by experiment with the real detector. The detector was prepared in clean rooms of Mid Sweden University and tested using both alpha particle and neutron sources. Sensitivity to thermal neutrons was confirmed. The neutron detection efficiency can be increased by preparing a thicker layer of TiB₂ but the optimal point between the converter thickness and the neutron conversion product range in the conversion layer can be found [9]. An optimal thickness of the conversion layer can be determined using a simulation. Another way of increasing sensitivity could be by means of a transition from planar technology to that of three-dimension; the surface area is increased by holes, pyramids, pillars, etc, filled with the converter [10]

Detector Simulation

In order to optimize the manufacturing process, a Geant4 Monte-Carlo toolkit was used to simulate the performance of the neutron detector. A silicon photo diode was coated with titanium, TiB₂ and aluminium thin films. Neutrons are captured by ¹⁰B, which is about 19.8% of the contained boron, and converted to alpha particles. These in turn are absorbed by the silicon detector and converted into electron/hole pairs. The thickness of the converter layer was varied in order to find its optimal effectiveness. Additional simulations ensured that gamma radiation, which is emitted during the radioactive decays or neutron capture reactions, did not disturb the detected alpha peak.

Detector Structure

Neutron detection in semiconductor devices can only be achieved through nuclear reactions that emit energetic particles such as α- or β-particles that create electron/hole pairs in the semiconductor when absorbed. The cross section of the neutron converter is preferably large allowing for thinner neutron converting layers. Its isotopic abundance should be high so as to improve effectiveness. It should be possible to discriminate the absorbed particles against y-radiation which is usually a byproduct of nuclear reactions.

A reason for the choice of TiB₂ as a conductive conversion material was because it can be handled by standard clean room techniques such as electron beam evaporation or sputtering. TiB₂ is a very hard ceramic material with 4.5 g/cm³, a high melting point and fairly low resistance. In comparison with ¹⁰B, titanium itself is nearly transparent to slow neutrons, whereas ¹⁰B (with a natural abundance of 19.8%) acts as an converter with its thermal neutron cross section of 3849b. The ¹⁰B(n, α) reaction can be written as:

$${}_{5}^{10} B + {}_{0}^{1} n \begin{matrix}{}_{3}^{7} Li + α & Q = 2.79 MeV \\ {}_{3}^{7}{Li}{}_{}^{*} + α & Q = 2.31 MeV\end{matrix}$$

whereas 94% of all reactions result in the excited state of ⁷Li (*) with energies for Li and the α-particle of E_{L}=0.84 MeV and E₀=1.47 MeV.

The second decay has a probability of 6% sending out an a-particles with 1.78 MeV. The prototype silicon detector has dimensions of 5 mm×5 mm×300 μm with an epitaxial layer of 50 μm that is coated with metal layers and the converter material.

Monte Carlo Simulation in Geant4

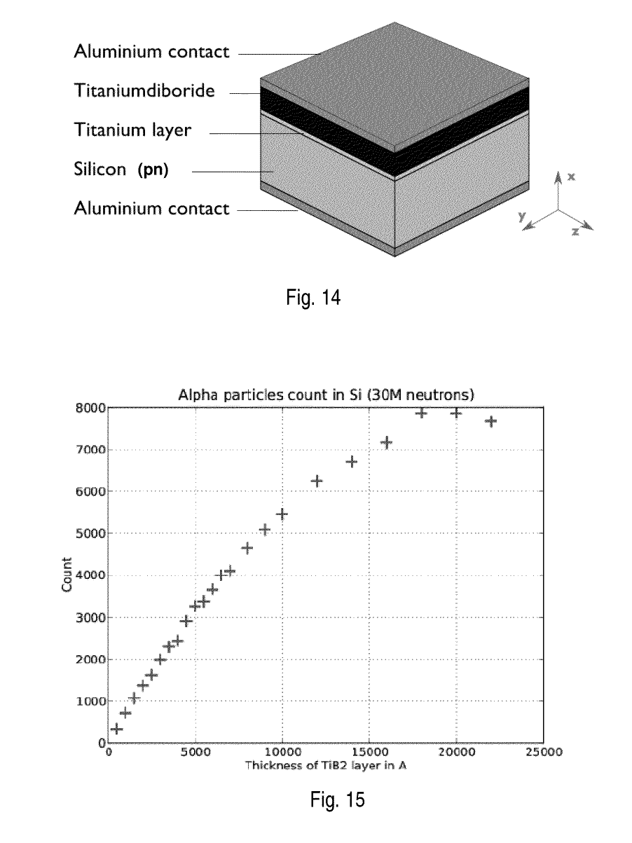

The simulated part of the structure is a silicon PN-detector of 5 mm×5 mm×50 μm and different metal coatings, see FIG. 14. Only the active silicon epi-layer of 50 μm was simulated in this case. The detector was placed in a cubic world volume of 100 mm edge length defined as a vacuum. The general particle source was placed along the x-axis at approximately 5 mm above the device. It was used both for the simulation of neutron and gamma radiation. Materials were defined using the NIST material database with a natural isotopic composition.

TiB₂ layers of different thickness were simulated directly onto silicon starting at 500 Å in several steps up to 22000 Å. In a second sequence of simulations, this procedure was repeated including all the layers that were processed in the physical device, i.e. a coating of 500Å Ti, the TiB₂ layer and a 3000 Å Al contact (see FIG. 14).

Finally, a TiB₂ layer thickness of 2000 Å was selected for all following simulations of the manufactured device for which each of them was run using 30×10⁶ neutrons. Since an ²⁴¹AmBe source emits not only neutrons but also gamma radiation from de-excitation after the decay processes and the Be (a, n) C-process, additional simulations with regard to gamma rays were also run for these two devices. Additionally, it was verified that there is no detectable neutron ionization in the silicon by simulating a Si-detector coated with only aluminium contact layers. Pure thermal neutrons with an energy of 0.025 eV were used throughout all the simulations.

Dimensions of the Converter Layer

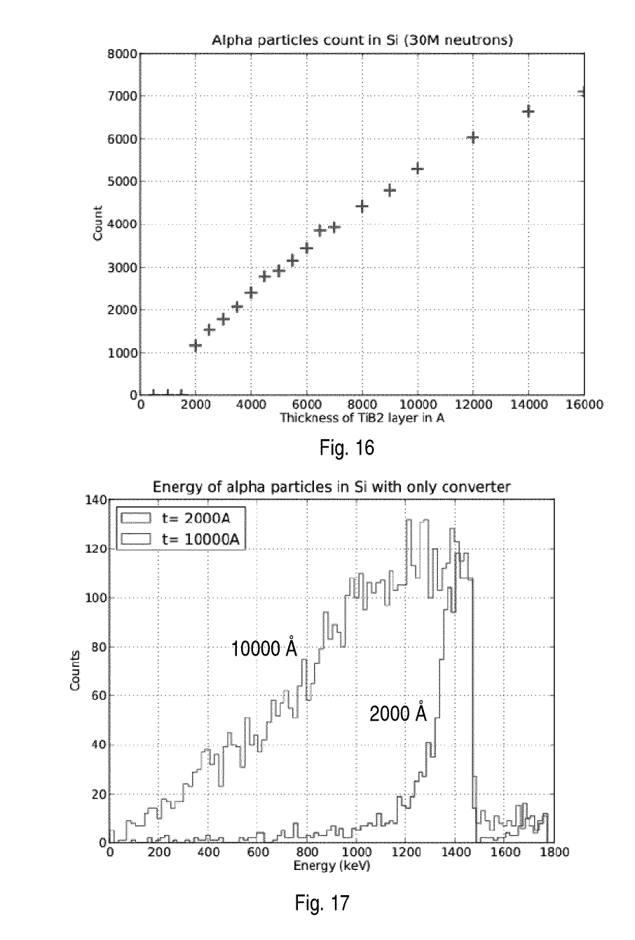

Different layer thicknesses of TiB₂, directly deposited on silicon, were simulated. In a second step titanium and aluminium layers were added to the TiB₂ layer. The simulation results were written to an ASCII file and then converted to the HDF5 file format in order to reduce the amount of data. The analysis of the data was performed in Scientific Python. FIG. 15 shows the number of detected alpha particles after 30×10⁶ neutrons were plotted over the thickness of the layer. It can be seen that the number saturates at about 20000 Å thickness of the neutron converter layer. This is due to the fact that the TiB₂ starts to act as an a-particle absorber. A simulation that includes a Ti and a Al layer shows that less a-particles reach the detector, which was to be expected, see FIG. 16.

Even though the number of absorbed a-particles in silicon is higher at thicker layers it is not necessarily better to use such a layer. FIG. 17 shows results for the 2000 Å and 10000 Å TiB₂ on silicon. The peak for the thicker layer is much wider than for the other one. In a thick converter layer some of the a-particles loose energy before they hit the sensitive detector.

Full Scale Detector Simulation

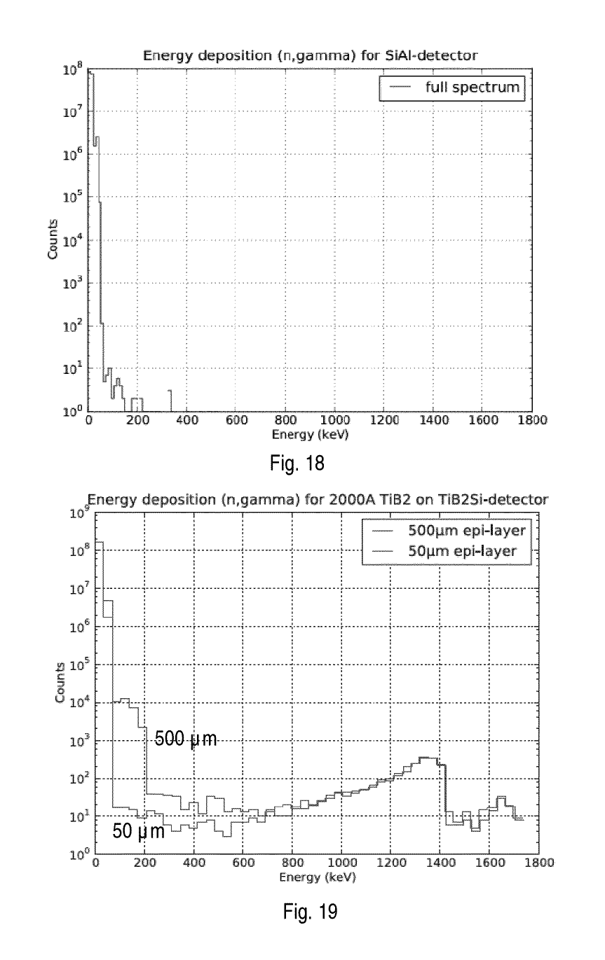

FIG. 18 shows the results for a simulated detector featuring only the aluminium contact layer on silicon. 30×10⁶ neutrons and the corresponding γ-photons were used to simulate the device. It can be seen that only a part of the gamma radiation is absorbed. There is no visible interaction of neutrons with silicon.

Finally, the results of a simulation with all layers on the detector and neutron and gamma radiation (n, gamma) are shown in FIG. 19. Again 30×10⁶ neutrons were simulated and combined with the results of the corresponding gamma photons. The Bragg curve from 1.47 MeV α-particles is clearly visible on the background noise from the gamma radiation and it is even possible to see the peak from the 1.78 MeV α-particles in the plot. The overall effectiveness of neutron conversion in the full detector featuring all layers is about 0.002%.

Measured Results

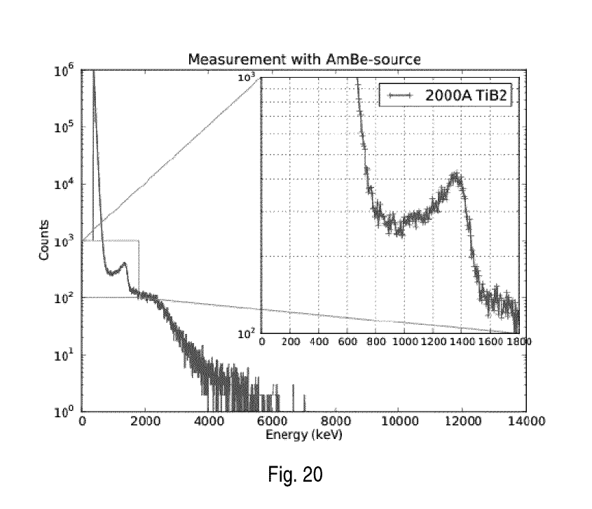

The measurements were conducted using an ²⁴¹AmBe neutron source that emits about 3.7×10⁶ neutrons per second. The detector was placed in the opening of the source close to the moderator and left for about 15 hours. FIG. 20 shows the number of counts per energy bin. The enlarged cut-out shows the same energy range that was used in the plots showing the simulation results. The peak from the detected α-particles at 1.47 MeV is clearly visible.

### CONCLUSION

The results of the simulation suggest that it is possible to build such a device and this has also been demonstrated herein. Measurement results from the neutron detector show a high similarity with the simulation results. A converter layer thickness of 2000 Å appears to be reasonable in order to distinguish the α-peak from the gamma radiation background. By using an epitaxial layer on a silicon substrate it was possible to effectively suppress the background noise from absorbed gamma radiation. The efficiency of the neutron converter leaves can be further improved, for example, with ¹⁰B enriched TiB₂. Alternatively, or in addition, a 3D neutron converting layer could be used to improve the efficiency.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

### REFERENCES

[1] R. T. Kouzes, The 3He Supply Problem, PNNL-18388, Pacific Northwest National Laboratory, Richland, Wash.
[2] H. Spieler, Semiconductor Detector Systems, Oxford University Press, USA, 2005.
[3] S. M. Sze, Physics of Semiconductor Devices, Wiley, N.Y., 1981.
[4] R. M. Munro, Material Properities of Titanium Diboride, J. Res. Natl. Inst. Stand. Technol. 105, 709-720 (2000).
[5] J. Singh, F. Quli, D. E. Wolfe, J. T. Schriempf, J. Singh, An Overview: Electron Beam—Physical Vapor Deposition Technology—Present and Future, The Applied Research Laboratory, The Pennsylvania State University.
[6] MaTeck GmbH, 22Ti, http://www.mateck.de/HiPuMa/srvCat_e.asp.id.titanium.html.
[7] G. F. Knoll, Radiation detection and measurements, John Willey and Sons, Inc., New York 2000.
[8] Czech Metrology Institute, Czech National Standards—family of standards: ionising radiation, radioactivity, http://www.cmi.cz/index.php?lang=2%par=&wdc=72&act=.
[9] J. Jakubek, S. Pospisil, J. Uher, J. Vacik, D. Vavrik, Properties of the single neutron pixel detector based on the Medipix-1 device, NIM A, Volume 531, Issues 1-2, Proceedings of the 5th |WORID, Pages 276-284, 2004.
[10] J. Uher, Highly sensitive Silicon Detectors of Thermal Neutrons (Supervisor: S. Pospisil), Ph.D. Thesis, CTU Prague, 2006.

1. A neutron detector comprising:
a semiconductor detector substrate having a front side and a back side;
a first electrical contact present on said front side and comprises a conductive neutron converting layer; and
a second electrical contact present on said back side and comprises a conductive layer.

2. The neutron detector according to claim 1, wherein said conductive neutron converting layer is made of a conductive material comprising isotopes that are sensitive to neutrons and convert incident neutrons to detectable particle species.

3. The neutron detector according to claim 1, wherein said conductive neutron converting layer is made of a conductive boride material.

4. The neutron detector according to claim 3, wherein said conductive neutron converting layer is made of titanium diboride.

5. The neutron detector according to claim 4, wherein said conductive neutron converting layer is made of enriched titanium diboride with regard to a ¹⁰B isotope and boron in said enriched titanium diboride is present in at least 20% as said ¹⁰B isotope.

6. The neutron detector according to claim 1, wherein said conductive neutron converting layer has a thickness from about 100 nm to about 1 μm.

7. The neutron detector according to claim 1, wherein said semiconductor detector substrate comprises a three-dimensional structure in said front side.

8. The neutron detector according to claim 7, wherein said front side is serrated forming multiple sawteeth and said first electrical contact is deposited on said sawteeth.

9. The neutron detector according to claim 1, wherein said first electrical contact comprises a conductive gluing layer arranged between said conductive neutron converting layer and said semiconductor detector substrate.

10. The neutron detector according to claim 9, wherein said conductive gluing layer is one of a titanium layer and a chrome layer.

11. The neutron detector according to claim 9, wherein said conductive gluing layer has a thickness from about 10 nm to about 100 nm.

12. The neutron detector according to claim 1, wherein said first electrical contact comprises a conductive metal layer arranged on a first side of said conductive neutron converting layer that is opposite to a second side of said conductive neutron converting layer facing said semiconductor detector substrate.

13. The neutron detector according to claim 12, wherein said conductive metal layer is made of a metal selected from a group consisting of aluminum, silver, gold and titanium.

14. The neutron detector according to claim 12, wherein said conductive metal layer is made of a same conductive metal material as said conductive layer and has a thickness that is substantially the same as a thickness of said conductive layer.

15. The neutron detector according to claim 1, wherein said conductive layer is a conductive metal layer made of a metal selected from a group consisting of aluminum, silver, gold and titanium.

16. The neutron detector according to claim 1, wherein said conductive layer has a thickness from about 100 nm to about 1 μm.

17. The neutron detector according to claim 1, wherein said neutron detector is a pixel-based neutron detector with said conductive layer arranged in a form of multiple separate metal portions forming a grid on said back side.

18. The neutron detector according to claim 17, wherein said semiconductor detector substrate is doped to comprise a PN-junction and a distance between said PN-junction in said semiconductor detector substrate and said neutron converting layer is longer than a distance between said PN-junction in said semiconductor detector substrate and said conductive layer.

19. The neutron detector according to claim 1, wherein said semiconductor detector substrate is a silicon-based detector substrate.

20. The neutron detector according to claim 1, wherein said semiconductor detector substrate is doped to comprise a PN-junction.

21. The neutron detector according to claim 20, wherein said semiconductor detector substrate has a p-type semiconductive part facing said conductive neutron converting layer and a remaining n-type semiconductive part.

22. The neutron detector according to claim 20, wherein a distance between said PN-junction in said semiconductor detector substrate and said neutron converting layer is shorter than a distance between said PN-junction in said semiconductor detector substrate and said conductive layer.

23. The neutron detector according to claim 1, wherein said neutron detector is configured to detect at least one of thermal neutrons, epithermal neutrons and resonance neutrons.

24. The neutron detector according to claim 1, further comprising:
a second semiconductor detector layer having a front side and a back side, said back side of said second semiconductor detector layer is connected to a first side of said first electrical contact opposite to a second side of said first electrical contact connected to said semiconductor detector layer; and
a third electrical contact present on said back side of said second semiconductor and comprises a conductive layer.
